(19) United States
(12) Patent Application Publication
(10) Pub. No.: US 2022/0231555 A1
(43) Pub. Date: Jul. 21, 2022

(54) AXIAL FLUX MOTOR HAVING A MECHANICALLY INDEPENDENT STATOR

(71) Applicant: GATES CORPORATION, Denver, CO (US)

(72) Inventors: Vigel Russalian, Macomb, MI (US); George Spehar, Clarkston, MI (US); Stephen M. Reaburn, LaSalle (CA)

(21) Appl. No.: 17/578,426

(22) Filed: Jan. 18, 2022

Related U.S. Application Data
(60) Provisional application No. 63/139,018, filed on Jan. 19, 2021.

(51) Int. Cl. H02K 1/2795; H02K 3/28; H02K 7/00

(52) U.S. Cl. CPC H02K 1/2795; H02K 7/003; H02K 3/28

(57) ABSTRACT

An axial flux motor comprising a modular stator assembly and a rotor assembly is provided.

### FIELD OF THE INVENTION

Embodiments of the present invention generally relate to an axial flux motor used in many applications without significant modifications. More particularly, embodiments of the present invention are directed to an axial flux motor comprising a mechanically independent modular stator assembly configured to accept various rotor assembly configurations.

### BACKGROUND OF THE INVENTION

Those of ordinary skill in the art will appreciate axial flux motors are often used in pumps that employ impellers or other rotating components configured to move water, oil, and other fluids. Axial flux motors are also used to spin fans, electronic storage media, etc. One advantage of using axial flux motors is their size because they can be scaled very easily. Indeed, components of brushless DC motors are often incorporated directly into printed circuit boards.

Axial flux motors generally consist of a stator spaced from a rotor. As the name implies, “axial” refers to the fact that a gap between the stator and rotor is aligned with, or parallel to, the axis of rotor rotation. The stator is usually an electromagnet formed of a conductor wound about by one or more cores, which are often metallic. A housing accommodates the stator. The rotor employs one or more permanent magnets. In operation, energizing the electromagnet or altering the current therethrough will produce a constant or variable magnetic field that interacts with the magnetic field of the rotor's permanent magnets. Selective alteration of the electromagnetic field's polarity spins the rotor. The rotor is interconnected to a shaft that is interconnected to an impeller blade, gear, fan, etc.

Integrating a brushless DC motor into an automobile often requires a great deal of effort. For example, adapting existing DC motors into an automobile often requires changes to the motor's stator housing. The internal components of the stator also may require modification, which is expensive and time-consuming. More specifically, brushless DC motors are usually integrated units, wherein the stator assembly, rotor assembly, control board, and respective housings are configured in a single unit. Thus, a change in the motor application necessarily requires housing and internal componentry design changes, which leads to increased component costs and lead times.

Some automotive applications of axial flux motors include pumps for pumping a fluid, particularly a cooling liquid in an internal combustion engine or other application requiring a cooling fluid circulating pump.

Representative of the art is US patent application 2015/0030479 that discloses a wet rotor pump with an axial flux motor. The stator is arranged in a dry zone while the rotor on an impeller is arranged in a wet zone. The rotor is formed by one or more samarium cobalt (SmCo) permanent magnets.

Representative art further includes US patent application 2017/0016449 that discloses a pump comprising a housing partially defining a cavity, an impeller arranged in the cavity, the impeller including a first disk, and a vane arranged on the first disk, the impeller operative to rotate about a rotational axis, a first stator core arranged on the housing, windings arranged on the first stator core, and a first inlet defined by the housing, wherein the first inlet, the impeller, and the housing partially define a fluid flow path.

It is the long-felt need to provide an axial flux motor having modular components wherein a standard stator assembly is configured to receive multiple rotor assemblies.

### SUMMARY OF THE INVENTION

It is one aspect of some embodiments of the present invention to provide an axial flux motor consisting of a stator assembly and a rotor assembly. The rotor assembly comprises a rotor having a plurality of permanent magnets interconnected via at least one bearing to a rotor housing. The rotor may include an integrated shaft for interconnection to a fan or impeller. Alternatively, the rotor is operatively interconnected to a shaft that receives the fan or rotor. The rotor assembly housing is configured to receive additional components, such as nozzles or tubing associated with its task—water pump, oil pump, etc. The rotor assembly housing also includes a flange for selective interconnection to a corresponding flange of the stator assembly. The stator assembly accommodates the stator, consisting of stator cores wound by wire to form electromagnets. The stator's magnetic force interacts with the magnetic field of the permanent magnets to impart to rotor rotation.

Those of ordinary skill in the art will appreciate stator assemblies and rotor assemblies must be placed adjacent to each other for the motor to work properly. It is one aspect of the embodiments of the present invention to provide a modular stator assembly that can be used in multiple applications. Embodiments of the present invention are primarily directed to a modular and mechanically independent stator assembly having an integrated control board. The associated rotor is incorporated into application-specific housings, wherein the stator assembly is the same regardless of the application. It follows that application-specific software is fed to the integrated control board. Further, the contemplated stator assemblies of some embodiments do not possess any moving parts, e.g., shafts, wherein interaction between the stator assembly and the interconnected application-specific rotor assembly is driven purely though magnetic forces. The drawings, described in further detail below, show the stator assembly used in oil and water pump applications.

The term “a” or “an” entity, as used herein, refers to one or more of that entity. As such, the terms “a” (or “an”), “one or more” and “at least one” can be used interchangeably herein. Further, the phrases “at least one,” “one or more,” and “and/or,” as used herein, are open-ended expressions that are both conjunctive and disjunctive in operation. For example, each of the expressions “at least one of A, B and C,” “at least one of A, B, or C,” “one or more of A, B, and C,” “one or more of A, B, or C,” and “A, B, and/or C” means A alone, B alone, C alone, A and B together, A and C together, B and C together, or A, B and C together.

Unless otherwise indicated, all numbers expressing quantities, dimensions, conditions, and so forth used in the specification and drawing figures are to be understood as being approximations that may be modified in all instances as required for a particular application of the novel assembly and method described herein.

The use of “including,” “comprising,” or “having” and variations thereof herein is meant to encompass the items listed thereafter and equivalents thereof as well as additional items. Accordingly, the terms “including,” “comprising,” or “having” and variations thereof can be used interchangeably herein.

It shall be understood that the term “means” as used herein shall be given its broadest possible interpretation in accordance with 35 U.S.C., Section 112(f). Accordingly, a claim incorporating the term “means” shall cover all structures, materials, or acts set forth herein, and all of the equivalents thereof. Further, the structures, materials, or acts and the equivalents thereof shall include all those described in the Summary, Brief Description of the Drawings, Detailed Description and in the appended drawing figures.

The Summary of the Invention is neither intended nor should it be construed as being representative of the full extent and scope of the present invention. That is, these and other aspects and advantages will be apparent from the disclosure of the invention(s) described herein. Further, the above-described embodiments, aspects, objectives, and configurations are neither complete nor exhaustive. As will be appreciated, other embodiments of the invention are possible using, alone or in combination, one or more of the features set forth above or described below. Moreover, references made herein to “the present invention” or aspects thereof should be understood to mean certain embodiments of the present invention and should not necessarily be construed as limiting all embodiments to a particular description. The present invention is set forth in various levels of detail in the Summary of the Invention as well as in the attached drawings and the Detailed Description and no limitation as to the scope of the present invention is intended by either the inclusion or non-inclusion of elements, components, etc. in this Summary of the Invention. Additional aspects of the present invention will become more readily apparent from the Detailed Description, particularly when taken together with the drawings.

### BRIEF DESCRIPTION OF THE DRAWINGS

The accompanying drawings, which are incorporated in and constitute a part of the specification, illustrate embodiments of the invention and, together with the general description of the invention given above and the detailed description of the drawings given below, explain the principles of these inventions.

FIG. 1 is a perspective view of the axial flux motor of one embodiment of the present invention used in conjunction with an oil pump;

FIG. 2 is a cross-sectional view of FIG. 1;

FIG. 3 is another cross-sectional view of FIG. 1 that primarily shows the stator assembly;

FIG. 4 is a front perspective view of the stator assembly;

FIG. 5, is a rear perspective view of the stator assembly;

FIG. 6 is a perspective view of a stator core of one embodiment of the present invention;

FIG. 7 is a perspective view of stator coils used in conjunction with the stator core shown in FIG. 6;

FIG. 8 is a cross-section of a rotor assembly of one embodiment of the present invention configured to be used with an oil pump;

FIG. 9 is a perspective view of an axial flux motor of another embodiment of the present invention used in conjunction with a water pump;

FIG. 10 is a cross-sectional view of FIG. 9; and

FIG. 11 is a cross-sectional view of the rotor assembly used in the embodiment shown in FIG. 9.

It should be understood that the drawings are not necessarily to scale. In certain instances, details that are not necessary for an understanding of the invention or that render other details difficult to perceive may have been omitted. It should be understood, of course, that the invention is not necessarily limited to the particular embodiments illustrated herein.

### DETAILED DESCRIPTION

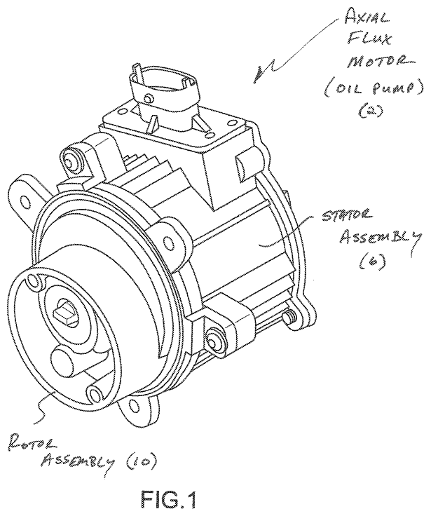

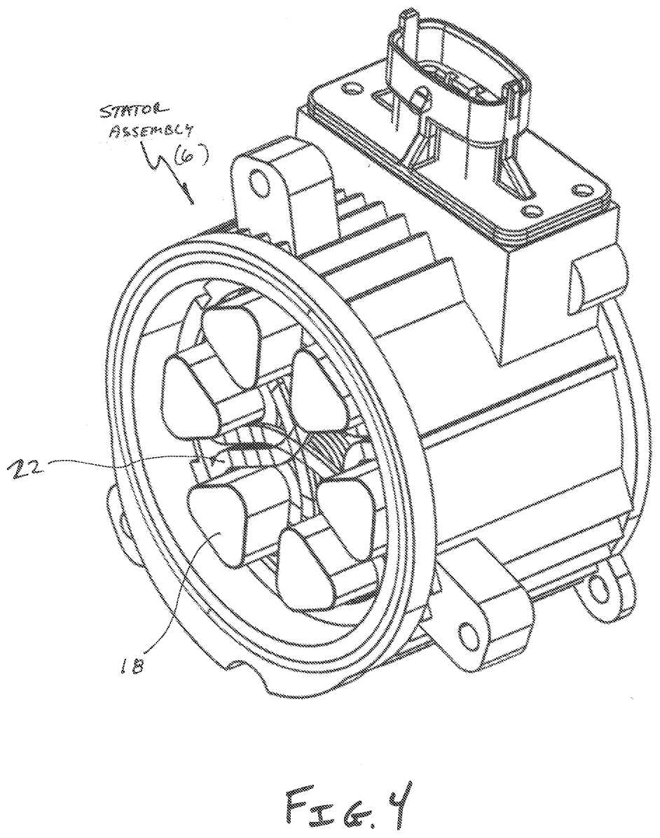

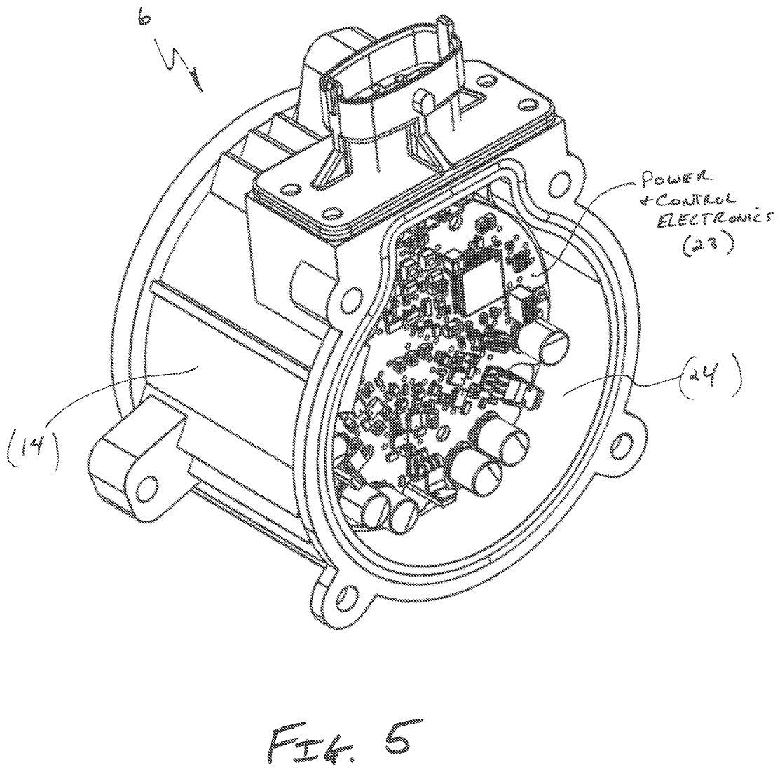

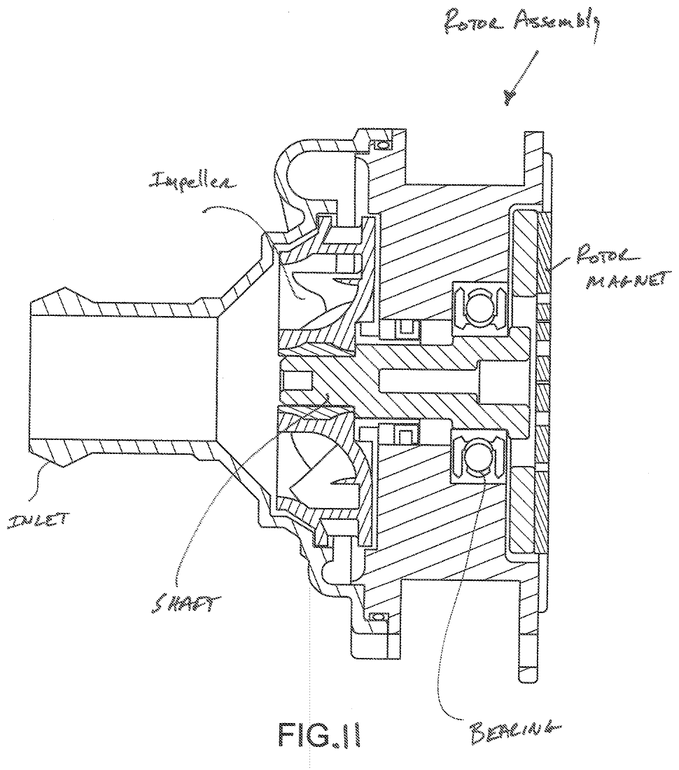

FIGS. 1-11 show an axial flux motor 2 consisting of a stator assembly 6 interconnected to a rotor assembly 10. The stator assembly 6 of embodiments of the present invention is modular in that it can accept rotor assemblies 10 of various configurations. For example, the stator assembly shown can accept a rotor assembly configured to be used in an oil pump or a water pump. Those of ordinary skill in the art will appreciate the contemplated stator assembly may accept other rotor assemblies.

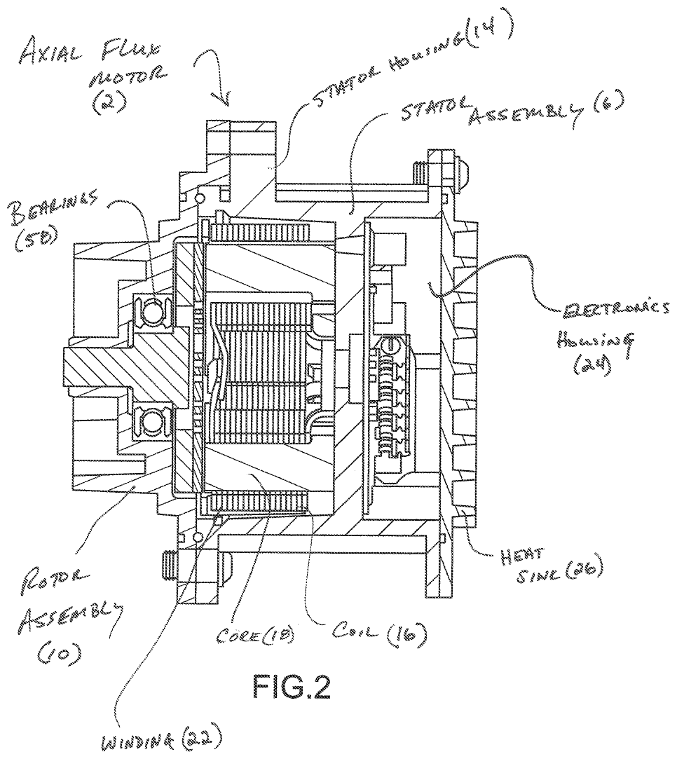

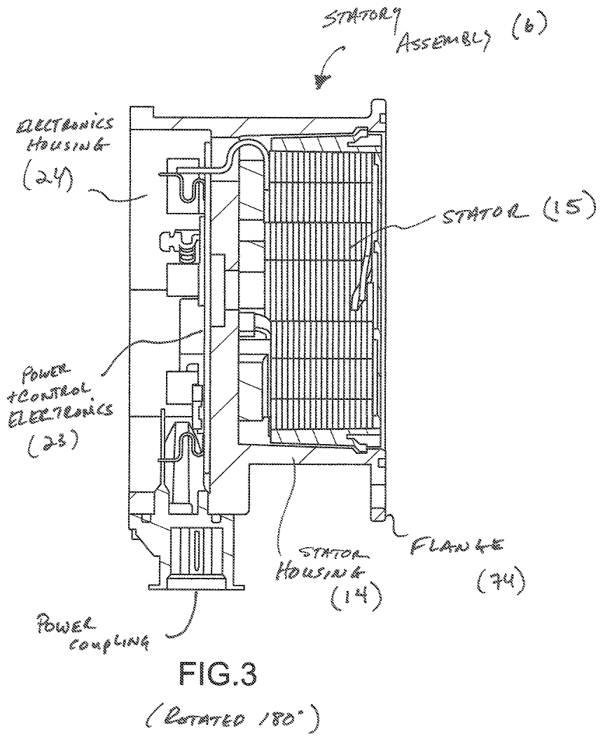

FIGS. 2 and 3 are cross-sections showing the stator assembly of FIG. 1. The stator assembly 6 comprises a stator housing 14 that accommodates a stator 15 formed of a plurality of electromagnets. More specifically, the stator 15 consists of a yoke 16 with a plurality of cores 18 extending therefrom that receive electric wire windings 22. The wound cores, thus, form a magnetic pole. The cores may be prismatic, having a substantially triangular cross section. Thermal potting, which is well known, may be used in the stator housing to enrobe the stator. Thermal potting causes the axial flux motor to run cooler by providing a reliable means of heat transfer from the stator and stator housing. Heating typically occurs by iron and copper losses and resistance heating from eddy currents induced in the stator and windings by the varying magnetic field, or by conduction to the housing from the cooling fluid being pumped (in the case of a water pump application), and from an engine block (in an automotive application) or other environment of use (not shown). Again, it is a primary aspect of some embodiments of the present invention to provide a stator assembly 6 that can accept and function with rotor assemblies of various configurations.

Power and control electronics 23 are disposed in an electronics housing 24 associated with the stator housing 14. The power electronics control shaft rotational speed and can also detect faults. The electronics housing also accommodates a control unit configured to selectively control the amount and character of electricity flowing through the wires to create magnetic fields in the electromagnets. The control method may comprise PWM, LIN protocol/bus, or CAN protocol/bus. A LIN bus is a sub-bus system based on a serial communications protocol. The bus is a single master/multiple slave bus that uses a single wire to transmit data. Controller Area Network or CAN protocol is a method of communication between various electronic devices like engine management systems, water pumps, oil pumps, active suspension, ABS, gear control, lighting control, air conditioning, airbags, central locking embedded in an automobile. PWM or pulse width modulation is a type of digital signal that is used in a variety of applications, including control circuitry. The housing may also include a heat sink 26 designed to dissipate heat generated by the stator. A connector is provided that is in electrical communication with the control unit, a power source, etc.

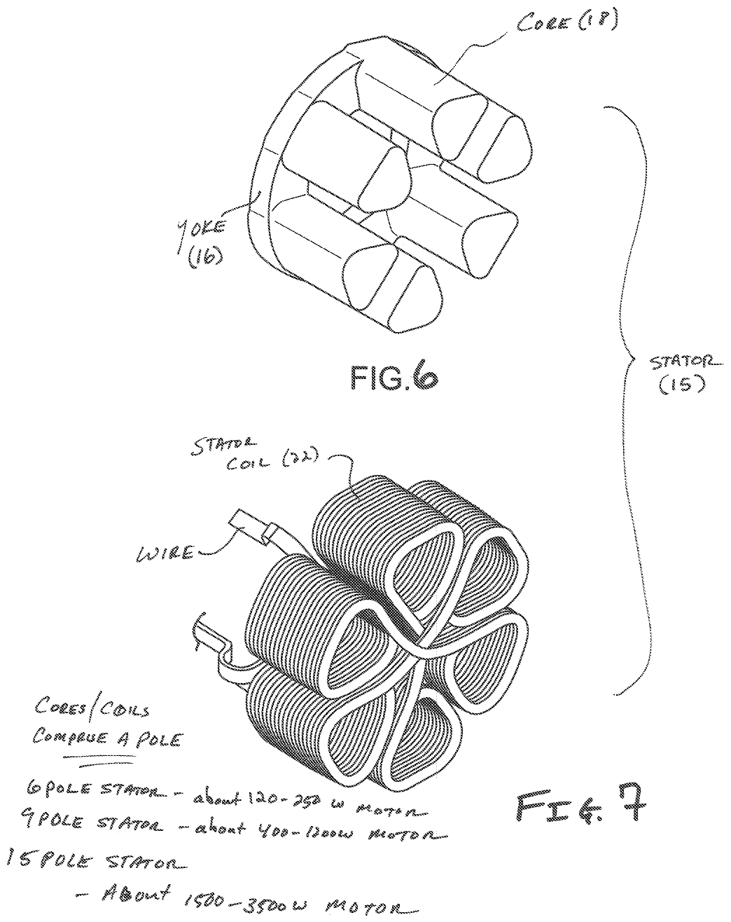

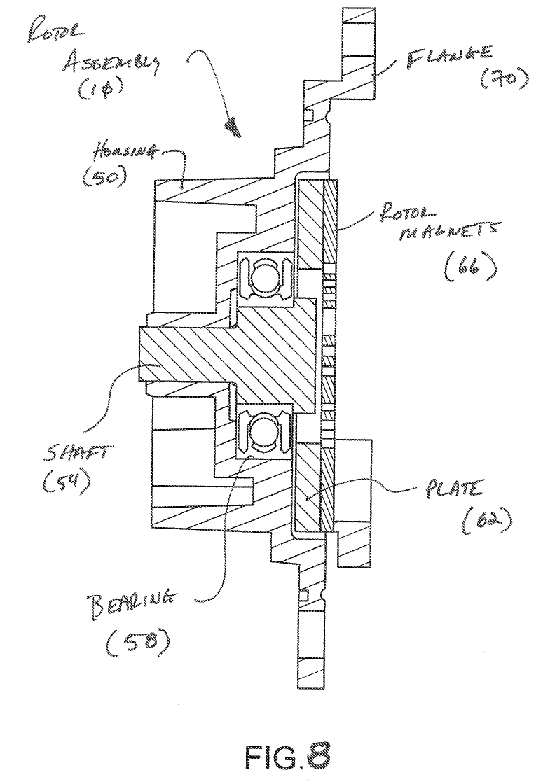

FIGS. 6 and 7 show the stator components that should be familiar to those of ordinary skill in the art. Again, the stator core is formed of a yoke 16 with a plurality of cores 18 extending therefrom. The wire coils 22 consists of a plurality, e.g., six, coils placed about each core 18. The windings may comprise wires with round or flat cross-sections. A flat wire may have a square or rectangular cross-section. The flat wire or round wire may be made of copper or aluminum. A winding plane of windings extends normal to the shaft axis, so the magnetic flux extends in the axial direction. The motor of one embodiment employs a stator with six poles and has a power rating of about 120 W-250 W. Other embodiments employ nine pole or fifteen pole stators and produce about 400 W-1200 W and 1500 W-3500 W, respectively. Indeed, in some embodiments of the present invention, the stator poles are reduced in length such that the stator coils are integrated into a printed circuit board.

The internal volume of the stator assembly, including the central portion at the middle of the cores, may accommodate at least one wire extending therethrough. The internal volume of the stator assembly, including the central portion at the middle of the cores, may be potted fully. Thus the stator assembly may possess a stator with a substantially closed internal volume. One of skill in the art will appreciate that the coil shown prevents the stator's use of a shaft traditionally found in many brushless DC motors. Also, the contemplated stator assemblies of some embodiments do not possess any moving parts, e.g., shafts or bearings. The rotor shaft does not extend into the stator housing or pass through the stator. The interaction between the stator assembly and the interconnected application-specific rotor assembly is driven purely though magnetic forces. In other words, the rotor may reside entirely within the rotor housing, the shaft does not extend across the boundary between the rotor housing and the stator housing, and the stator resides entirely within the stator housing.

In one embodiment, a traditional or 3D hall effect position sensor is located in the center (i.e., generally corresponding to a longitudinal axis of the yoke) and interconnected to the motor's control circuitry. The contemplated hall effect sensor is designed to reduce motor startup time and will be embedded in the above-mentioned potting, wherein a sensing surface is exposed towards the rotor side. Those of skill in the art will appreciate that hall effect sensors work by sensing the direction of the magnetic field from the rotor. Accordingly, the rotor will have one of its magnets extended or an additional magnet is employed for generating a position sensing magnetic field.

FIG. 8 shows a rotor assembly 10 used in the axial flux motor of FIG. 1. The rotor assembly consists of a housing 50 that accommodates a shaft 54 interconnected to the housing by at least one bearing 58. The bearing 58 may comprise an integral bearing wherein shaft 54 comprises the bearing inner race. Further, the bearing may comprise either a double row ball bearing or double row ball-roller bearing. The contemplated roller bearing may comprise cylindrical or tapered rollers. The use of a single bearing is made possible by the short length of the pump shaft afforded by the axial flux motor configuration of one embodiment.

The shaft is interconnected to a plate 62 that accommodates a plurality of rotor magnets 66. The plurality of magnets may comprise a ring magnet with poles about the circumference or a plurality of individual magnets with poles in alternating positions. The magnet may comprise ferrite, rare earth, or other known materials. Magnets are attached to the plate using known methods. For example, the permanent magnets may be adhered to the plate. Those of ordinary skill in the art will appreciate that in some instances, the permanent magnets are secured to the plate with glue, but other interconnection mechanisms, such as interference fit, welding, etc. can be used.

An alternate manufacturing method, the rotor is made of a sintering process wherein powdered materials, one of which is magnetic, are compressed in a die and perhaps heated to form the rotor. A magnet is later introduced to the rotor to create magnetized areas on the rotor that generate a permanent magnetic field. An example of this manufacturing process is discussed in U.S. Provisional Patent Application Ser. No. 62/959,010 (Reference No. 019-056), which is incorporated by reference herein.

An air gap is in the range of 0.2 mm to 1.5 mm is provided between the rotor and the stator of one embodiment. The gap is preferably as small as possible to realize maximum magnetic efficiency. A flange 70 may be employed to interconnect the rotor assembly 10 to a complementary flange 74 of the stator assembly (see FIG. 3, for example). In operation, magnetic fields generated by the stator interact with magnetic fields of the rotor magnets 66 to spins the shaft to operate the pump, for example.

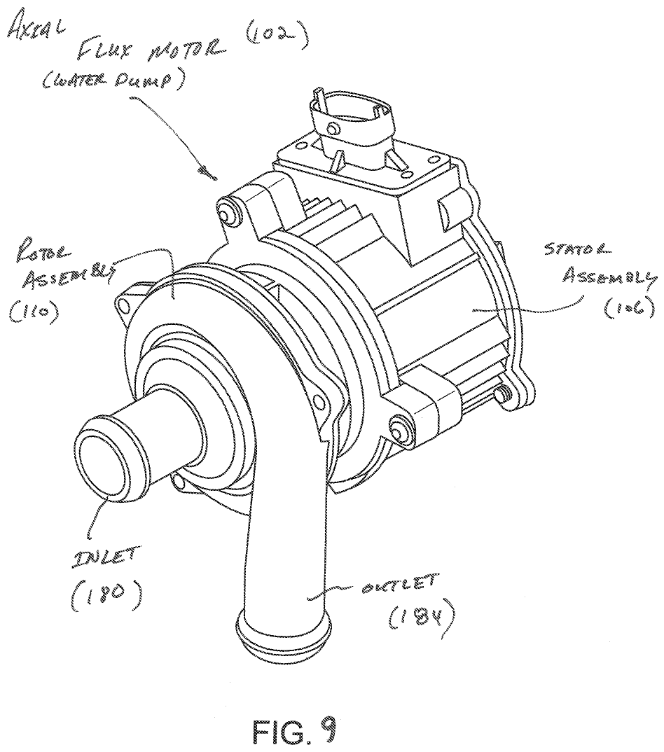

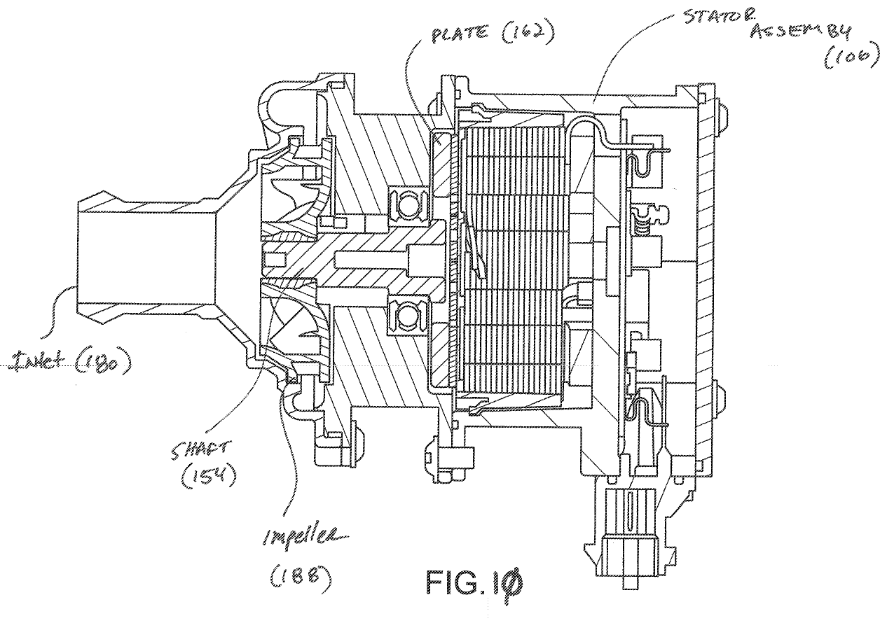

FIG. 9-11 show an axial flux motor 102 of another embodiment of the present invention integrated into a water pump. Here, the stator assembly 106 is the same configuration as that shown in FIG. 2. However, the rotor assembly 110 is slightly different, wherein it is configured to operate as a water pump with an inlet 180 and outlet 184. The plate 162 of one embodiment of the present invention is interconnected to a shaft 154 is connected to an impeller 188. In operation, the impeller spins to move fluid from the inlet to the outlet, which should be understood by those of ordinary skill in the art. It is important to note that the stator assembly 106 components are the same as in the embodiment shown in FIG. 1.

Exemplary characteristics of embodiments of the present invention have been described. However, to avoid unnecessarily obscuring embodiments of the present invention, the preceding description may omit several known apparatus, methods, systems, structures, and/or devices one of ordinary skill in the art would understand are commonly included with the embodiments of the present invention. Such omissions are not to be construed as a limitation of the scope of the claimed invention. Specific details are set forth to provide an understanding of some embodiments of the present invention. It should, however, be appreciated that embodiments of the present invention may be practiced in a variety of ways beyond the specific detail set forth herein.

Modifications and alterations of the various embodiments of the present invention described herein will occur to those skilled in the art. It is to be expressly understood that such modifications and alterations are within the scope and spirit of the present invention, as set forth in the following claims. Further, it is to be understood that the invention(s) described herein is not limited in its application to the details of construction and the arrangement of components set forth in the preceding description or illustrated in the drawings. That is, the embodiments of the invention described herein are capable of being practiced or of being carried out in various ways. The scope of the various embodiments described herein is indicated by the following claims rather than by the foregoing description. And all changes which come within the meaning and range of equivalency of the claims are to be embraced within their scope. It is intended to obtain rights which include alternative embodiments to the extent permitted, including alternate, interchangeable and/or equivalent structures, functions, ranges or steps to those claimed, whether or not such alternate, interchangeable and/or equivalent structures, functions, ranges or steps are disclosed herein, and without intending to publicly dedicate any patentable subject matter.

The foregoing disclosure is not intended to limit the invention to the form or forms disclosed herein. In the foregoing Detailed Description, for example, various features of the invention are grouped together in one or more embodiments for the purpose of streamlining the disclosure. This method of disclosure is not to be interpreted as reflecting an intention that the claimed inventions require more features than expressly recited. Rather, as the following claims reflect, inventive aspects lie in less than all features of a single foregoing disclosed embodiment. Thus, the following claims are hereby incorporated into this Detailed Description, with each claim standing on its own as a separate preferred embodiment of the invention. Further, the embodiments of the present invention described herein include components, methods, processes, systems, and/or apparatus substantially as depicted and described herein, including various sub-combinations and subsets thereof. Accordingly, one of skill in the art will appreciate that would be possible to provide for some features of the embodiments of the present invention without providing others. Stated differently, any one or more of the aspects, features, elements, means, or embodiments as disclosed herein may be combined with any one or more other aspects, features, elements, means, or embodiments as disclosed herein.

We claim:

1. An axial flux motor, comprising:
a stator assembly comprising a stator housing that accommodates a plurality of stator cores mounted in a yoke, each stator core comprising an electric wire winding;
a rotor assembly comprising a rotor housing that is interconnected by way of at least one bearing to a shaft, a plate interconnected to the shaft, and a plurality of magnets interconnected to the plate;
wherein the stator assembly is configured to interconnect to a rotor assembly of a first configuration and a rotor assembly of a second configuration without modification.

2. The axial flux motor of claim 1, wherein the rotor assembly of a first configuration is associated with an oil pump, and the rotor assembly of a second configuration is associated with a water pump, wherein the shaft is interconnected to an impeller.

3. The axial flux motor of claim 1, wherein the stator housing includes a flange that engages a flange of the rotor housing.

4. The axial flux motor of claim 1, wherein the stator comprises a plurality of prismatically-shaped cores that receive corresponding stator coils.

5. The axial flux motor of claim 1, wherein the rotor is manufactured in a sintering process comprising:
adding a first material to a die,
adding a second material to the die above the first material,
compressing the first material and the second material within the die, and
magnetizing the second material.

6. The axial flux motor of claim 1, wherein the electric wire winding comprises a flat wire.

7. The axial flux motor of claim 1, wherein the electric wire winding comprises a round wire.

8. The axial flux motor of claim 1, wherein the stator assembly includes an integrated control board.

9. The axial flux motor of claim 1, wherein the stator assembly and rotor assembly are not mechanically interconnected.

10. The axial flux motor of claim 1, wherein the stator assembly is devoid of any moving parts.

11. The axial flux motor of claim 1, wherein the stator assembly possess a stator with a substantially closed internal volume.

12. The axial flux motor of claim 1, wherein an internal volume of the stator assembly accommodates at least one wire extending therethrough.

13. The axial flux motor of claim 1, wherein the rotor resides entirely within the rotor housing, the shaft does not extend across the boundary between the rotor housing and the stator housing, and the stator resides entirely within the stator housing.
